(19) United States
(12) Patent Application Publication
(10) Pub. No.: US 2021/0024847 A1
(43) Pub. Date: Jan. 28, 2021

(54) COMPOSITIONS OF POLYMER COMPOSITES FOR EFFLUENTS DELIVERY AND APPLICATIONS THEREOF

(71) Applicant: ADAPTIVE SURFACE TECHNOLOGIES, INC., Cambridge, MA (US)

(72) Inventors: Joseph LOMAKIN, Arlington, MA (US); John Travis HUNSUCKER, Melbourne Beach, FL (US); Chetan Anirudh KHATRI, Acton, MA (US); Philseok KIM, Waltham, MA (US)

(21) Appl. No.: 17/044,222

(22) PCT Filed: Mar. 30, 2019
(86) PCT No.: PCT/US2019/025071

§ 371 Date: Sep. 30, 2020

Related U.S. Application Data
(60) Provisional application No. 62/650,968, filed on Mar. 30, 2018.

(51) Int. Cl. C10M 107/50; C10M 107/38; C10M 107/34

(52) U.S. Cl. CPC C10M 107/50; C10M 107/38; C10M 107/34; C10N 2050/08; C10M 2213/0623; C10M 2209/1045; C10M 2229/0465

(57) ABSTRACT

Coating compositions, coatings, and coated articles are provided exhibiting drag-reducing properties. The drag reduction can lead to improved flow, e.g. an improved measure of slip length, over both laminar and turbulent flow conditions, e.g. for Reynolds numbers less than 2,000 to as much as about 500,000. The coating compositions include abase matrix and an effluent polymer dispersed in the base resin in such a way that, when an exposed surface of the drag-reducing coating is exposed to an aqueous medium, the effluent polymer migrates to the exposed surface of the drag-reducing coating and into the aqueous medium at or near the exposed surface to create a diluted effluent polymer solution in the aqueous medium at or near the exposed surface; wherein the diluted effluent polymer solution reduces a drag of the surface moving through the aqueous medium.

### CROSS-REFERENCE TO RELATED APPLICATIONS

This application claims priority to, and the benefit of, co-pending U.S. provisional application entitled “COMPOSITIONS OF SLIPPERY POLYMER COMPOSITES FOR EFFLUENTS DELIVERY AND APPLICATIONS THEREOF” having Ser. No. 62/650,968, filed Mar. 30, 2018, the contents of which are incorporated by reference in their entirety.

### TECHNICAL FIELD

The present disclosure generally relates to coatings and surfaces, and in particular to multifunctional coatings and surfaces that are slippery and/or non-stick, create dynamic slip at a boundary, and autonomously deliver payloads/effluents in the vicinity of a boundary to further reduce friction from turbulence.

### BACKGROUND

The propulsion powering needs for a displacement ship primarily come from the need to overcome frictional resistance between the hull and the water. Because ships typically operate at high Reynolds number the boundary layer on a ship is assumed to be turbulent from the onset of the flow, as only portions very near the bow (<1 m) would have a possibility of being laminar. Friction drag can constitute 50% of the drag on surface ships and roughly 65% of the drag on submarines. Existing solutions for reducing friction drag include drag reduction polymers and microbubbles, which have shown 70-80% reduction in skin-friction drag coefficient in the laboratory but have not proven as promising in real-world applications. Ejection systems for ejecting polymers or microbubbles at or near the area of minimum pressure in the nose portion of a moving vehicle have been developed, but are complex and have not delivered the desired levels of performance.

Biofilm formation on ship hulls add to inefficiencies and can lead to large increases in the skin friction drag. As regulations continue to restrict the use of biocides in antifouling paints, biofouling is likely to play an increasing role in frictional resistance unless improved solutions are developed.

There remains a need for improved solutions for overcoming frictional resistance between the hull and the water in marine vessels, as well as solutions that can also impart biofouling protection.

### BRIEF DESCRIPTION OF THE DRAWINGS

Further aspects of the present disclosure will be readily appreciated upon review of the detailed description of its various embodiments, described below, when taken in conjunction with the accompanying drawings.

FIG. 1 is a schematic depicting the time-averaged velocity gradient a) on conventional surface, b) on a slippery liquid-infused porous surface where the lubricant provides an increase in slip between the fluid and the surface, c) on a drag-reducing surface where the polymer additive reduces drag by elongating and decreasing the fluid interaction in the turbulent boundary layer, and d) on a combined surface where the two approaches are combined: the slippery surface lubricant is engineered to release into the boundary layer where it reduces the turbulence, thereby providing two combined mechanisms for drag reduction.

FIG. 2 is a schematic of a submarine having a drag-reducing coating applied to the front/nose portion and a slippery liquid-infused porous surface coating applied to a remainder of the surface. The drag-reducing coating reduces drag by elongating and decreasing the fluid interaction in the turbulent boundary layer, while the slippery surface coating provides an increase in slip between the fluid and the surface. Both coatings can also provide anti-biofouling properties.

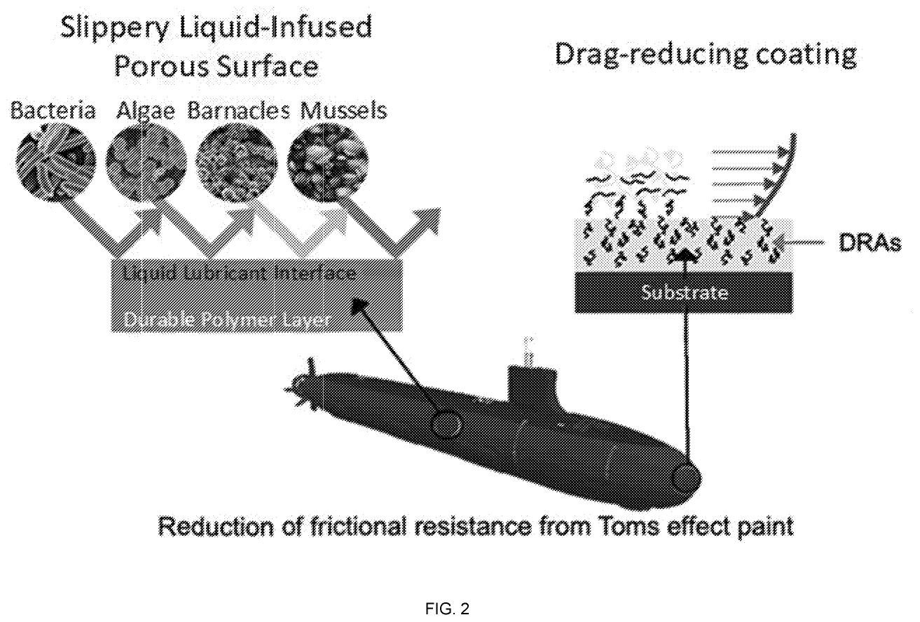

### SUMMARY

In various aspects, this disclosure is directed to coatings and surfaces, methods and compositions for making coatings on surfaces, coated surfaces and articles, and uses thereof. In some aspects, the coatings can spontaneously elute and deliver an effluent or a payload (e.g. dilute polymer molecules) in the vicinity of the boundary of liquid-liquid interface and within the surrounding fluid medium without utilizing an active mechanism (e.g. pumping of the effluent dilute polymers). In this way, the coatings can reduce drag via the Toms effect.

In some aspects, the compositions include a base resin composition capable of curing to form a coating on the surface; and an effluent polymer dispersed in the base resin in such a way that, when an exposed surface of the drag-reducing coating is exposed to an aqueous medium, the effluent polymer migrates to the exposed surface of the drag-reducing coating and into the aqueous medium at or near the exposed surface to create a diluted effluent polymer solution in the aqueous medium at or near the exposed surface; wherein the diluted effluent polymer solution reduces a drag of the surface moving through the aqueous medium.

In some aspects, the base resin composition includes (i) a curable thermoset or thermoplastic polymer resin and (ii) polymerizable monomers; wherein upon curing the polymerizable monomers polymerize inside the thermoset or thermoplastic polymer to form an interpenetrating polymer network; and wherein the effluent polymer is diffused within the interpenetrating polymer network and swells the interpenetrating polymer network to form a effluent polymer swollen gel.

In some aspects, the base resin composition includes (i) polymerizable first monomers capable of polymerization to form a curable thermoset or thermoplastic polymer resin and (ii) a polymerizable second monomers; wherein upon curing the polymerizable first monomers polymerize inside the thermoset or thermoplastic polymer to form an interpenetrating polymer network; and wherein the effluent polymer is diffused within the interpenetrating polymer network and swells the interpenetrating polymer network to form a effluent polymer swollen gel.

In some aspects, the effluent polymer is covalently attached to the base resin, e.g. via a hydrolysable linkage where the hydrolysable linkage includes polydimethylsiloxane dithiol, 4-arm-PEG-maleimide, PEG-diester-dithiol, reaction products of an amine and an N-hydroxy succinimide, reaction products of a polyglycerol and a sebasic acid, or one of the derivatives thereof.

In some aspects, the effluent polymer is encapsulated within a hydrolysable shell. Such shells are known in the art, e.g. polydimethylsiloxane, poly(oxyethylene), poly(oxypropylene), copolymers thereof, or blends thereof.

The composite composition according to claim 21, wherein the effluent polymer is a hydrophilic polymer.

In some aspects, the effluent polymer has an average molecular weight of about 100,000 Daltons or more. In some aspects, the effluent polymer is selected from the group Poly(N-isopropylacrylamide), Polyacrylamide, Poly(2-oxazoline), Polyethylenimine, Poly(acrylic acid), Polymethacrylate, Poly(ethylene glycol), Polyglycerol, Poly(ethylene oxide), Poly(alkylene glycol), Polysaccharide, Poly(vinyl alcohol), Poly(vinylpyrrolidone), Polyelectrolytes, Cucurbit[n]uril Hydrate, Maleic Anhydride Copolymers, Polyethers, Polyvinyl alcohol-co-polyvinyl acetate, co-polymers thereof, and blends thereof.

In some aspects, the effluent polymer is a polyelectrolyte such as Poly(styrenesulfonate), Polyacrylamide-based Polyelectrolytes, Poly(acrylic acid) salts, Poly(allylamine hydrochloride), Poly(diallyldimethylammonium chloride), Poly(vinyl acid), co-polymers thereof, and blends thereof.

Drag-reducing coatings are also provided. The coatings can be prepared by methods include applying a composition described herein to a surface of a substrate and curing and/or drying the composition to form the drag-reducing coating on the surface. In some aspects, the coatings are applied to a marine vessel.

In some aspects, the surfaces are capable of supporting a stable liquid layer infused in a porous matrix, creating a slippery lubricating surface that can repel objects to be repelled from the surface. The surfaces can be essentially free of pinning points leading to improved performance, low contact angle hysteresis on the surface, and improved service lifetime.

In another aspect, the surfaces can generate a slip boundary (non-zero slip length) by presenting and maintaining a mobile and immiscible liquid phase at the boundary with respect to the surrounding immiscible fluid medium moving at a speed, where the boundary between the two immiscible fluids is essentially a liquid-liquid interface.

In another aspect, the surfaces can be created on the surface of marine platforms, vessels (e.g. cargo ships, racing boats, ferries, recreational ships, yachts), vehicles (e.g. unmanned underwater vehicles), and naval warfare (e.g. naval ships, submarines, torpedoes, stealth vehicles) to reduce drag and thereby to enhance the range or speed per same propulsion power.

The disclosed coatings and surfaces can be formulated into a paint or a coatings product that can be applied on a solid surface, where the paint or coating product provides multifunctional and combined advantages including slippery, non-stick, biofouling-resistant, friction reducing, and drag reducing functions.

In another embodiment, the paint or coating product above further reduces hydroacoustic noise and signature by minimizing the interactions among the fluid particles and the surfaces of a moving object.

In another embodiment, the paint or coating product above further controls body cavitation by dynamically manipulating the surface wettability.

In another embodiment, the paint or coating product above further improves visibility through optically clear coating in submerged environment by reducing the attachment of biofouling and/or contaminants.

In another embodiment, the paint or coating product above further reduces drag associated with biofouling.

Other systems, methods, features, and advantages of the coatings, surfaces, methods, compositions, articles, and uses thereof will be or become apparent to one with skill in the art upon examination of the following drawings and detailed description. It is intended that all such additional systems, methods, features, and advantages be included within this description, be within the scope of the present disclosure, and be protected by the accompanying claims.

### DETAILED DESCRIPTION

A major contributor to the overall drag for almost all naval platforms is the friction between the surface of the moving object and the fluid. These frictional drag forces arise because the fluid very near the surface is traveling at the same speed as the surface and the fluid some distance from the surface is moving at a different speed. The differences in velocity generate stresses that can constitute upwards of 80% to 90% of the total drag incurred by a large ship.

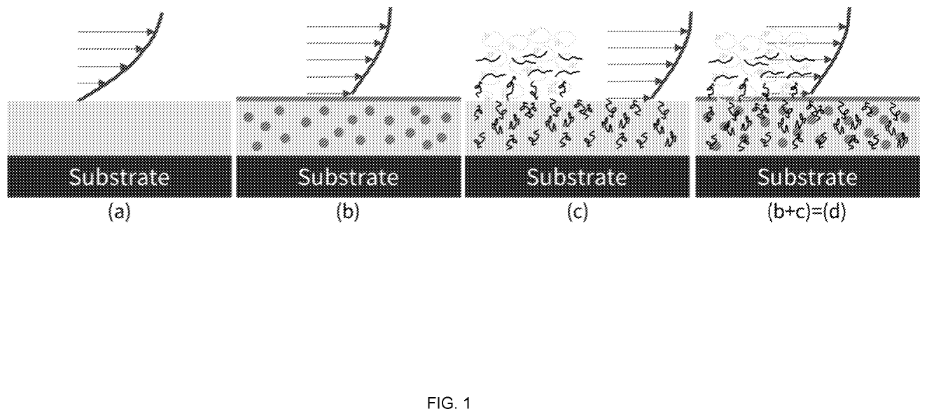

Coatings based on slippery liquid-infused porous surfaces (SLIPS® coatings) made of a porous medium that traps a liquid, such as a lubricant, in and on the surface have been shown to reduce drag up to 35% from controlled laboratory experiments. These work by releasing lubricant on the surface that increases the slippage at the intersection of the fluid and the surface of the object (FIG. 1, panel b).

In turbulent flow conditions, large local fluctuations in the medium velocity occur close to the surface, creating much higher energy loss as compared to laminar flow, and thereby increasing the drag experienced. Drag-reducing coatings can also employ a Toms effect by eluting a drag reducing agent such as a polymer effluent at or near the surface. At or near the surface, a long-chain dilute polymer can be autonomously delivered into the layer adjacent to the object, this delivery has been shown to reduce drag by decreasing turbulence due to the fluid interaction in the turbulent boundary layer (FIG. 1, panel c). In some aspects, coatings provided herein include an effluent polymer dispersed in the base resin in such a way that, when an exposed surface of the drag-reducing coating is exposed to an aqueous medium, the effluent polymer migrates to the exposed surface of the drag-reducing coating and into the aqueous medium at or near the exposed surface to create a diluted effluent polymer solution in the aqueous medium at or near the exposed surface. In some aspects, the drag-reducing coating employs a Toms effect, wherein the diluted effluent polymer solution reduces a drag of the surface moving through the aqueous medium.

In some aspects, this disclosure demonstrates examples of using both a slippery liquid-infused polymer surface coating to increase slippage, while also employing the Toms effect to reduce turbulence thereby giving a combined drag reduction effect. The drag reduction effect can result in surfaces with a slip length greater than 0 over a large range of Reynolds numbers from laminar to turbulent flow, e.g. for a fluid flowing at a Reynolds number of less than 2,000, for a fluid flowing at a Reynolds number of about 2,000 to about 10,000, and even for a fluid flowing at a Reynolds number of about 10,000 to about 500,000.

These coatings can be engineered to reduce the frictional drag of an immersed body using a two-tiered mechanism: 1) a dynamic liquid interface engineered to release lubricant on the surface will increase the slippage at the intersection of the fluid and the surface of the object (FIG. 1, panel b) and 2) a long-chain dilute polymer can be autonomously delivered into the layer adjacent to the object, this delivery has been shown to reduce drag by decreasing the fluid interaction in the turbulent boundary layer (FIG. 1, panel c). In some aspects, a single coating can utilize both mechanisms simultaneously (FIG. 1, panel d), the coating can provide a passively working solution to achieve significant drag reduction in naval applications. In some aspects, a first coating can be applied to the nose region of a marine vessel where the first coating releases an effluent polymer to reduce drag through the Toms effect. A second coating can be applied to other parts of the marine vessel, e.g. in the stern region or the rest of the entire hull. The second coating can be a slippery coating such as a slippery liquid-infused polymer coating to increase the slippage of the effluent polymer and medium passing the surface. One or both of the first coating and the second coating can include additional additives such as biocides or anti-microbials.

To enable a coating system that can achieve drag reduction without any need for active control, the technology can be used in conjunction with drag reduction compositions. The lubricants and polymers needed for the combined drag reduction effect can be stored in the porous structure of the polymer coating which are designed to be released during the operational life of the immersed body. Engineering of such compositions is not trivial and the present disclosure describes such compositions of matter.

Previous disclosures on the compositions of slippery polymer (see, e.g. PCT/US2014/025935, PCT/US2013/050406, and PCT/US2017/025889) teach specific examples of constructing lubricant-infused polymer systems that can create lubricious overlayer (LOL) on exposed surfaces that can contribute to the drag reduction at the boundary layer. However, the incorporation of effluent dilute polymer that is designed to leave the porous polymer network to aid reduction of turbulence in the vicinity of the boundary layer is not taught and requires entirely different compositions of matter to enable such a concept while maintaining the lubricious overlayer.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting. The skilled artisan will recognize many variants and adaptations of the embodiments described herein. These variants and adaptations are intended to be included in the teachings of this disclosure and to be encompassed by the claims herein.

All publications and patents cited in this specification are cited to disclose and describe the methods and/or materials in connection with which the publications are cited. All such publications and patents are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Although any methods and materials similar or equivalent to those described herein can also be used in the practice or testing of the present disclosure, the preferred methods and materials are now described. Functions or constructions well-known in the art may not be described in detail for brevity and/or clarity. Embodiments of the present disclosure will employ, unless otherwise indicated, techniques of nanotechnology, organic chemistry, material science and engineering and the like, which are within the skill of the art. Such techniques are explained fully in the literature.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

### Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

Throughout the application, where language such as having, including, or comprising is used to describe specific components or process steps, it is contemplated that other aspects exist that consist essentially of, or consist of the specific components or process steps.

The term “substantially free” as used in this context means the reaction product and/or coating compositions contain less than 1000 parts per million (ppm), “essentially free” means less than 100 ppm and “completely free” means less than 20 parts per billion (ppb) of any of the above compounds or derivatives or residues thereof. The term “about,” as used herein, means approximately, in the region of, roughly, or around. When the term “about” is used with a numerical value, it modifies that value by extending the boundaries above and below the numerical value set forth. For example, in some aspects, the term “about” is used herein to modify a numerical value above and below the stated value by a variance of ±20%, ±15%, or ±10% of the stated value. In some aspects, the term “about” can reflect traditional uncertainties in experimental measurements and/or traditional rounding according to significant figures of the numerical value.

The term “alkyl” refers to the radical of saturated aliphatic groups, including straight-chain alkyl groups, branched-chain alkyl groups, cycloalkyl (alicyclic) groups, alkyl-substituted cycloalkyl groups, and cycloalkyl-substituted alkyl groups.

In some aspects, a straight chain or branched chain alkyl has 30 or fewer carbon atoms in its backbone (e.g., C₁-C₃₀ for straight chains, C₃-C₃₀ for branched chains), 20 or fewer, 12 or fewer, or 7 or fewer. Likewise, in some embodiments cycloalkyls have from 3-10 carbon atoms in their ring structure, e.g. have 5, 6 or 7 carbons in the ring structure. The term “alkyl” (or “lower alkyl”) as used throughout the specification, examples, and claims is intended to include both “unsubstituted alkyls” and “substituted alkyls”, the latter of which refers to alkyl moieties having one or more substituents replacing a hydrogen on one or more carbons of the hydrocarbon backbone. Such substituents include, but are not limited to, halogen, hydroxyl, carbonyl (such as a carboxyl, alkoxycarbonyl, formyl, or an acyl), thiocarbonyl (such as a thioester, a thioacetate, or a thioformate), alkoxyl, phosphoryl, phosphate, phosphonate, a hosphinate, amino, amido, amidine, imine, cyano, nitro, azido, sulfhydryl, alkylthio, sulfate, sulfonate, sulfamoyl, sulfonamido, sulfonyl, heterocyclyl, aralkyl, or an aromatic or heteroaromatic moiety.

Unless the number of carbons is otherwise specified, “lower alkyl” as used herein means an alkyl group, as defined above, but having from one to ten carbons, or from one to six carbon atoms in its backbone structure. Likewise, “lower alkenyl” and “lower alkynyl” have similar chain lengths. Throughout the application, preferred alkyl groups are lower alkyls. In some embodiments, a substituent designated herein as alkyl is a lower alkyl.

It will be understood by those skilled in the art that the moieties substituted on the hydrocarbon chain can themselves be substituted, if appropriate. For instance, the substituents of a substituted alkyl may include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Cycloalkyls can be substituted in the same manner.

The term “heteroalkyl”, as used herein, refers to straight or branched chain, or cyclic carbon-containing radicals, or combinations thereof, containing at least one heteroatom. Suitable heteroatoms include, but are not limited to, 0, N, Si, P, Se, B, and S, wherein the phosphorous and sulfur atoms are optionally oxidized, and the nitrogen heteroatom is optionally quaternized. Heteroalkyls can be substituted as defined above for alkyl groups.

The term “alkylthio” refers to an alkyl group, as defined above, having a sulfur radical attached thereto. In some embodiments, the “alkylthio” moiety is represented by one of —S-alkyl, —S-alkenyl, and —S-alkynyl. Representative alkylthio groups include methylthio, and ethylthio. The term “alkylthio” also encompasses cycloalkyl groups, alkene and cycloalkene groups, and alkyne groups. “Arylthio” refers to aryl or heteroaryl groups. Alkylthio groups can be substituted as defined above for alkyl groups.

The terms “alkenyl” and “alkynyl”, refer to unsaturated aliphatic groups analogous in length and possible substitution to the alkyls described above, but that contain at least one double or triple bond respectively.

The terms “alkoxyl” or “alkoxy” as used herein refers to an alkyl group, as defined above, having an oxygen radical attached thereto. Representative alkoxyl groups include methoxy, ethoxy, propyloxy, and tert-butoxy. An “ether” is two hydrocarbons covalently linked by an oxygen. Accordingly, the substituent of an alkyl that renders that alkyl an ether is or resembles an alkoxyl, such as can be represented by one of —O-alkyl, —O-alkenyl, and —O-alkynyl. Aroxy can be represented by —O-aryl or O-heteroaryl, wherein aryl and heteroaryl are as defined below. The alkoxy and aroxy groups can be substituted as described above for alkyl.

The terms “amine” and “amino” are art-recognized and refer to both unsubstituted and substituted amines, e.g., a moiety that can be represented by the general formula:

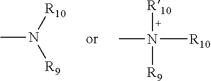

wherein R₉, R₁₀, and R′₁₀ each independently represent a hydrogen, an alkyl, an alkenyl, —(CH₂)ₘ— R₈ or R₉ and R₁₀ taken together with the N atom to which they are attached complete a heterocycle having from 4 to 8 atoms in the ring structure; R₈ represents an aryl, a cycloalkyl, a cycloalkenyl, a heterocycle or a polycycle; and m is zero or an integer in the range of 1 to 8. In some embodiments, only one of R₉ or R₁₀ can be a carbonyl, e.g., R₉, R₁₀ and the nitrogen together do not form an imide. In still other embodiments, the term “amine” does not encompass amides, e.g., wherein one of R₉ and R₁₀ represents a carbonyl. In additional embodiments, R₉ and R₁₀ (and optionally R′₁₀) each independently represent a hydrogen, an alkyl or cycloaklyl, an alkenyl or cycloalkenyl, or alkynyl. Thus, the term “alkylamine” as used herein means an amine group, as defined above, having a substituted (as described above for alkyl) or unsubstituted alkyl attached thereto, i.e., at least one of R₉ and R₁₀ is an alkyl group.

The term “amido” is art-recognized as an amino-substituted carbonyl and includes a moiety that can be represented by the general formula:

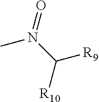

wherein R₉ and R₁₀ are as defined above.

“Aryl”, as used herein, refers to C₅-C₁₀-membered aromatic, heterocyclic, fused aromatic, fused heterocyclic, biaromatic, or bihetereocyclic ring systems. Broadly defined, “aryl”, as used herein, includes 5-, 6-, 7-, 8-, 9-, and 10-membered single-ring aromatic groups that may include from zero to four heteroatoms, for example, benzene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics”. The aromatic ring can be substituted at one or more ring positions with one or more substituents including, but not limited to, halogen, azide, alkyl, aralkyl, alkenyl, alkynyl, cycloalkyl, hydroxyl, alkoxyl, amino (or quaternized amino), nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN; and combinations thereof.

The term “aryl” also includes polycyclic ring systems having two or more cyclic rings in which two or more carbons are common to two adjoining rings (i.e., “fused rings”) wherein at least one of the rings is aromatic, e.g., the other cyclic ring or rings can be cycloalkyls, cycloalkenyls, cycloalkynyls, aryls and/or heterocycles. Examples of heterocyclic rings include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3 b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, pi peridonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl. One or more of the rings can be substituted as defined above for “aryl”.

The term “aralkyl”, as used herein, refers to an alkyl group substituted with an aryl group (e.g., an aromatic or heteroaromatic group).

The term “carbocycle”, as used herein, refers to an aromatic or non-aromatic ring in which each atom of the ring is carbon.

“Heterocycle” or “heterocyclic”, as used herein, refers to a cyclic radical attached via a ring carbon or nitrogen of a monocyclic or bicyclic ring containing 3-10 ring atoms, and preferably from 5-6 ring atoms, consisting of carbon and one to four heteroatoms each selected from the group consisting of non-peroxide oxygen, sulfur, and N(Y) wherein Y is absent or is H, O, (C₁-C₁₀) alkyl, phenyl or benzyl, and optionally containing 1-3 double bonds and optionally substituted with one or more substituents. Examples of heterocyclic ring include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH-carbazolyl, carbolinyl, chromanyl, chromenyl, cinnolinyl, decahydroquinolinyl, 2H,6H-1,5,2-dithiazinyl, dihydrofuro[2,3-b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxepanyl, oxetanyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydropyranyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl. Heterocyclic groups can optionally be substituted with one or more substituents at one or more positions as defined above for alkyl and aryl, for example, halogen, alkyl, aralkyl, alkenyl, alkynyl, cycloalkyl, hydroxyl, amino, nitro, sulfhydryl, imino, amido, phosphate, phosphonate, phosphinate, carbonyl, carboxyl, silyl, ether, alkylthio, sulfonyl, ketone, aldehyde, ester, a heterocyclyl, an aromatic or heteroaromatic moiety, —CF3, and —CN.

The term “carbonyl” is art-recognized and includes such moieties as can be represented by the general formula:

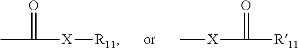

wherein X is a bond or represents an oxygen or a sulfur, and R₁₁ represents a hydrogen, an alkyl, a cycloalkyl, an alkenyl, an cycloalkenyl, or an alkynyl, R′₁₁ represents a hydrogen, an alkyl, a cycloalkyl, an alkenyl, an cycloalkenyl, or an alkynyl. Where X is an oxygen and R₁₁ or R′₁₁ is not hydrogen, the formula represents an “ester”. Where X is an oxygen and R₁₁ is as defined above, the moiety is referred to herein as a carboxyl group, and particularly when R₁₁ is a hydrogen, the formula represents a “carboxylic acid”. Where X is an oxygen and R′₁₁ is hydrogen, the formula represents a “formate”. In general, where the oxygen atom of the above formula is replaced by sulfur, the formula represents a “thiocarbonyl” group. Where X is a sulfur and R₁₁ or R′₁₁ is not hydrogen, the formula represents a “thioester.” Where X is a sulfur and R₁₁ is hydrogen, the formula represents a “thiocarboxylic acid.” Where X is a sulfur and R′₁₁ is hydrogen, the formula represents a “thioformate.” On the other hand, where X is a bond, and R₁₁ is not hydrogen, the above formula represents a “ketone” group. Where X is a bond, and R₁₁ is hydrogen, the above formula represents an “aldehyde” group.

The term “monoester” as used herein refers to an analogue of a dicarboxylic acid wherein one of the carboxylic acids is functionalized as an ester and the other carboxylic acid is a free carboxylic acid or salt of a carboxylic acid. Examples of monoesters include, but are not limited to, to monoesters of succinic acid, glutaric acid, adipic acid, suberic acid, sebacic acid, azelaic acid, oxalic and maleic acid.

The term “heteroatom” as used herein means an atom of any element other than carbon or hydrogen. Examples of heteroatoms are boron, nitrogen, oxygen, phosphorus, sulfur and selenium. Other heteroatoms include silicon and arsenic.

As used herein, the term “nitro” means —NO₂; the term “halogen” designates —F, —Cl, —Br or —I; the term “sulfhydryl” means —SH; the term “hydroxyl” means —OH; and the term “sulfonyl” means —SO₂—.

The term “substituted” as used herein, refers to all permissible substituents of the compounds described herein. In the broadest sense, the permissible substituents include acyclic and cyclic, branched and unbranched, carbocyclic and heterocyclic, aromatic and nonaromatic substituents of organic compounds. Illustrative substituents include, but are not limited to, halogens, hydroxyl groups, or any other organic groupings containing any number of carbon atoms, preferably 1-14 carbon atoms, and optionally include one or more heteroatoms such as oxygen, sulfur, or nitrogen grouping in linear, branched, or cyclic structural formats. Representative substituents include alkyl, substituted alkyl, alkenyl, substituted alkenyl, alkynyl, substituted alkynyl, phenyl, substituted phenyl, aryl, substituted aryl, heteroaryl, substituted heteroaryl, halo, hydroxyl, alkoxy, substituted alkoxy, phenoxy, substituted phenoxy, aroxy, substituted aroxy, alkylthio, substituted alkylthio, phenylthio, substituted phenylthio, arylthio, substituted arylthio, cyano, isocyano, substituted isocyano, carbonyl, substituted carbonyl, carboxyl, substituted carboxyl, amino, substituted amino, amido, substituted amido, sulfonyl, substituted sulfonyl, sulfonic acid, phosphoryl, substituted phosphoryl, phosphonyl, substituted phosphonyl, polyaryl, substituted polyaryl, C₃-C₂₀ cyclic, substituted C₃-C₂₀ cyclic, heterocyclic, substituted heterocyclic, aminoacid, peptide, and polypeptide groups.

Heteroatoms such as nitrogen may have hydrogen substituents and/or any permissible substituents of organic compounds described herein which satisfy the valences of the heteroatoms. It is understood that “substitution” or “substituted” includes the implicit proviso that such substitution is in accordance with permitted valence of the substituted atom and the substituent, and that the substitution results in a stable compound, i.e. a compound that does not spontaneously undergo transformation such as by rearrangement, cyclization, elimination, etc.

In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. The heteroatoms such as nitrogen may have hydrogen substituents and/or any permissible substituents of organic compounds described herein which satisfy the valencies of the heteroatoms.

In various embodiments, the substituent is selected from alkoxy, aryloxy, alkyl, alkenyl, alkynyl, amide, amino, aryl, arylalkyl, carbamate, carboxy, cyano, cycloalkyl, ester, ether, formyl, halogen, haloalkyl, heteroaryl, heterocyclyl, hydroxyl, ketone, nitro, phosphate, sulfide, sulfinyl, sulfonyl, sulfonic acid, sulfonamide, and thioketone, each of which optionally is substituted with one or more suitable substituents. In some embodiments, the substituent is selected from alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone, wherein each of the alkoxy, aryloxy, alkyl, alkenyl, alkynyl, amide, amino, aryl, arylalkyl, carbamate, carboxy, cycloalkyl, ester, ether, formyl, haloalkyl, heteroaryl, heterocyclyl, ketone, phosphate, sulfide, sulfinyl, sulfonyl, sulfonic acid, sulfonamide, and thioketone can be further substituted with one or more suitable substituents.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, thioketone, ester, heterocyclyl, —CN, aryl, aryloxy, perhaloalkoxy, aralkoxy, heteroaryl, heteroaryloxy, heteroarylalkyl, heteroaralkoxy, azido, alkylthio, oxo, acylalkyl, carboxy esters, carboxamido, acyloxy, aminoalkyl, alkylaminoaryl, alkylaryl, alkylaminoalkyl, alkoxyaryl, arylamino, aralkylamino, alkylsulfonyl, carboxamidoalkylaryl, carboxamidoaryl, hydroxyalkyl, haloalkyl, alkylaminoalkylcarboxy, aminocarboxamidoalkyl, cyano, alkoxyalkyl, perhaloalkyl, arylalkyloxyalkyl, and the like. In some embodiments, the substituent is selected from cyano, halogen, hydroxyl, and nitro.

As used herein, an “analog”, or “analogue” of a chemical compound is a compound that, by way of example, resembles another in structure but is not necessarily an isomer (e.g., 5-fluorouracil is an analog of thymine).

As used herein, a “derivative” of a compound refers to any compound having the same or a similar core structure to the compound but having at least one structural difference, including substituting, deleting, and/or adding one or more atoms or functional groups. The term “derivative” does not mean that the derivative is synthesized from the parent compound either as a starting material or intermediate, although this may be the case. The term “derivative” can include replacement of H by an alkyl, acyl, or amino group or a substituent described above. Derivatives can include compounds in which carboxyl groups in the parent compound have been derivatized to form salts, methyl and ethyl esters or other types of esters or hydrazides. Derivatives can include compounds in which hydroxyl groups in the parent compound have been derivatized to form O-acyl or O-alkyl derivatives. Derivatives can include compounds in which a hydrogen bond donating group in the parent compound is replaced with another hydrogen bond donating group such as OH, NH, or SH. Derivatives can include replacing a hydrogen bond acceptor group in the parent compound with another hydrogen bond acceptor group such as esters, ethers, ketones, carbonates, tertiary amines, imine, thiones, sulfones, tertiary amides, and sulfides.

Unless otherwise indicated, the term “polymer” includes both homopolymers and copolymers (e.g., polymers of two or more different monomers) and oligomers. Similarly, unless otherwise indicated, the use of a term designating a polymer class is intended to include homopolymers, copolymers and graft copolymers.

The term “molecular weight”, as used herein, generally refers to the mass or average mass of a material. If a polymer or oligomer, the molecular weight can refer to the relative average chain length or relative chain mass of the bulk polymer. In practice, the molecular weight of polymers and oligomers can be estimated or characterized in various ways including gel permeation chromatography (GPC) or capillary viscometry. GPC molecular weights are reported as the weight-average molecular weight (Mw) as opposed to the number-average molecular weight (Mn). Capillary viscometry provides estimates of molecular weight as the inherent viscosity determined from a dilute polymer solution using a particular set of concentration, temperature, and solvent conditions.

The term “small molecule”, as used herein, generally refers to an organic molecule that is less than 2000 g/mol in molecular weight, less than 1500 g/mol, less than 1000 g/mol, less than 800 g/mol, or less than 500 g/mol. Small molecules are non-polymeric and/or non-oligomeric.

The term “hydrophilic”, as used herein, refers to substances that have strongly polar groups that readily interact with water. Hydrophilic polymers can include acrylic acid homo- and co-polymers such as acrylamide, and maleic anhydride polymers and copolymers; amine-functional polymers such as allylamine, ethyleneimine, oxazoline, and other polymers containing amine groups in their main- or side-chains. The term hydrophilic, when used to refer to a polymer or oligomer, can mean a polymer or oligomer having a relative energy difference (RED=Rₐ/R₀, where Rₐ=Polymer/Solvent HSP Distance, R₀=Polymer Solubility Sphere Radius) of equal or less than 1 with respect to water in Hansen solubility space at 25° C.

The term “hydrophobic”, as used herein, refers to substances that lack an affinity for water; tending to repel and not absorb water as well as to not readily dissolve in or mix with water. The term hydrophobic, when used to refer to a polymer or oligomer, can mean a polymer or oligomer having a relative energy difference (RED=Rₐ/R₀, where Rₐ=Polymer/Solvent HSP Distance, R₀=Polymer Solubility Sphere Radius) greater than 1 with respect to water in Hansen solubility space at 25° C.

The term “amphiphilic”, as used herein, refers to a molecule combining hydrophilic and lipophilic (hydrophobic) properties. “Amphiphilic material” as used herein refers to a material containing a hydrophobic or more hydrophobic oligomer or polymer (e.g., biodegradable oligomer or polymer) and a hydrophilic or more hydrophilic oligomer or polymer. The term amphiphilic can refer to a polymer or oligomer having one or more hydrophobic oligomer segments and one or more hydrophilic oligomer segments as those terms are defined above.

Coatings, Coating Compositions, and Uses Thereof

A variety of coating compositions are described herein. The coating compositions can be used to form drag-reducing coatings for reducing the drag, in particular for marine applications. The coatings can be applied in the form of a paint to create a drag-reducing coating on a portion of the marine vessel. The coating compositions produce coatings that elute an effluent polymer into the aqueous medium (water) at an exposed surface of the coating. The effluent polymer creates a diluted effluent polymer solution in the aqueous medium at or near the exposed surface, which serves as a drag reducing agent for the Toms effect.

In some aspects, a coating composition for drag reduction includes a base resin composition capable of curing to form a coating on the surface; and an effluent polymer dispersed in the base resin in such a way that, when an exposed surface of the drag-reducing coating is exposed to an aqueous medium, the effluent polymer migrates to the exposed surface of the drag-reducing coating and into the aqueous medium at or near the exposed surface to create a diluted effluent polymer solution in the aqueous medium at or near the exposed surface; wherein the diluted effluent polymer solution reduces a drag of the surface moving through the aqueous medium.

Base Resin Compositions

The base resin composition can include prepolymer, polymerizable monomers, terminal-group functionalized oligomers or polymers, side-group functionalized oligomers or polymers, and/or telechelic oligomers or polymers. Telechelic polymers or end-functionalized polymers are macromolecules with two reactive end groups and are used as cross-linkers, chain extenders, and important building blocks for various macromolecular structures, including block and graft copolymers, star, hyperbranched or dendritic polymers. Telechelic polymers or oligomers can enter into further polymerization or other reactions through its reactive end-groups. By definition, a telechelic polymer is a di-end-functional polymer where both ends possess the same functionality. Where the chain-ends of the polymer are not of the same functionality they are termed end-functional polymers.

A low molecular weight prepolymer can be ‘cured’ or solidified by reaction of end-functionalized polymers with curing agents, which increases the molecular weight of the macromolecule. Exemplary curing agents include other oligomers or polymers with two or more reactive groups, or with bifunctional crosslinking agents. Exemplary telechelic polymers include polyether diols, polyester diols, polycarbonate diols, and polyalcadiene diols. Exemplary end-functionalized polymers also include polyacrylates, polymethacrylates, polyvinyls, and polystyrenes.

In some aspects, the polymers can include perfluorinated and/or polyfluorinated polymers. In other embodiments, the polymer precursor can be a perfluoroalkyl or polyfluoroalkyl monomer, such as perfluoroalkyl methacrylates. In other embodiments, an initiator may be included to initiate polymerization. For example, photoinitiators, thermal initiators, a moisture-sensitive catalyst or other catalyst can be included. Polymerization is effected by exposure of the compositions to a suitable trigger, such as light, including ultraviolet energy, thermal energy or moisture.

While curable polymers, oligomers and monomers are described for use as the solidifiable composition herein above, it is also possible to use polymers that do not permanently solidify, e.g., thermoplastics. A thermoplastic is a polymer that is solid below a specific temperature, but that becomes pliable or moldable when heated to above that specific temperature. Most thermoplastics have a high molecular weight and polymer chains that associate through intermolecular forces. This property allows thermoplastics to be remolded because the intermolecular interactions spontaneously reform upon cooling. In this way, thermoplastics differ from thermosetting polymers, which form irreversible chemical bonds during the curing process; thermoset bonds break down upon melting and do not reform upon cooling.

In one or more aspects, the prepolymer precursor includes fluorinated monomers or oligomers having some degree of unsaturation, such as (perfluorooctyl)ethyl methacrylate, or end functionalized with other reactive moieties that can be used in the curing process. For example, the monomers can be allyl based and include allyl heptafluorobutyrate, allyl heptafluoroisopropyl ether, allyl IH,IH-pentadecafluorooctyl ether, allylpentafluorobenzene, allyl perfluoroheptanoate, allyl perfluorononanoate, allyl perfluorooctanoate, allyl tetrafluoroethyl ether, and allyl trifluoroacetate. The monomers can be itacone- or maleate-based and include hexafluoroisopropyl itaconate, bis(hexafluoroisopropyl) itaconate; bis(hexafluoroisopropyl) maleate, bis(perfluorooctyl)itaconate, bis(perfluorooctyl)maleate, bis(trifluoroethyl) itaconate, bis(2,2,2-trifluoroethyl) maleate, mono-perfluorooctyl maleate, and mono-perfluorooctyl itaconate. The monomer can be acrylate- and methacrylate (methacrylamide)-base and include 2-(N-butylperfluorooctanesulfamido) ethyl acrylate, IH,IH,7H-dodecafluoroheptyl acrylate, trihydroperfluoroheptyl acrylate, IH,IH,7H-dodecafluoroheptyl methacrylate, trihydroperfluoroheptyl methacrylate, IH,IH,I IH-eicosafluoroundecyl acrylate, trihydroperfluoroundecyl acrylate, IH,IH,I IH-eicosafluoroundecyl methacrylate, trihydroperfluoroundecyl methacrylate, 2-(N-ethylperfluorooctanesulfamido)ethyl acrylate, 2-(N-ethylperfluorooctanesulfamido)ethyl methacrylate, 1H, 1H,2H,2H-heptadecafluorodecyl acrylate, IH,IH,2H,2H-heptadecafluorodecyl methacrylate, IH,IH-heptafluorobutylacrylamide, 1H, 1H-heptafluorobutyl acrylate, 1H, 1H-heptafluorobutylmethacrylamide, IH,IH-heptafluoro-n-butyl methacrylate, 1H,1H,9H-hexadecafluorononyl acrylate, IH,IH,9H-hexadecafluorononyl methacrylate, 2,2,3,4,4,4-hexafluorobutyl acrylate, 2,2,3, 4,4,4-hexafluorobutyl methacrylate, hexafluoroisopropyl acrylate, 1,1,1, 3,3, 3-hexafluoroisopropyl acrylate, IH,IH,5H-octafluoropentyl acrylate, IH,IH,5H-octafluoropentyl methacrylate, 2,2,3, 3,3-pentafluoropropyl acrylate, 2,2,3,3,3-pentafluoropropyl methacrylate, perfluorocyclohexyl methyl acrylate, perfluorocyclohexylmethyl methacrylate, perfluoroheptoxypoly(propyloxy) acrylate, perfluoroheptoxypoly(propyloxy) methacrylate, perfluorooctyl acrylate, IH,1H-perfluorooctyl acrylate, IH,1H-perfluorooctyl methacrylate and hexafluoroisopropyl methacrylate. Other suitable monomers include pentafluorostyrene, perfluorocyclopentene, 4-vinylbenzyl hexafluoroisopropyl ether, 4-vinylbenzyl perfluorooctanoate, vinyl heptafluorobutyrate, vinyl perfluoroheptanoate, vinyl perfluorononanoate, vinyl perfluorooctanoate, vinyl trifluoroacetate, tridecafluoro-I,I,2,2-tetrahydrooctyl-1,1-methyl dimethoxy silane, tridecafluoro-1,1,2,2-tetrahydrooctyl-1-dimethyl methoxy silane, and cinnamate.

Silicone monomers can also be used, such as PDMS precursor (i.e. Sylgard® 184), 1,4-bis[dimethyl[2-(5-norbornen-2-yl)ethyl]silyl]benzene, 1,3-dicyclohexyl-1, 1,3,3-tetrakis(dimethylsilyloxy)disiloxane, 1,3-dicyclohexyl-1, 1,3,3-tetrakis(dimethylvinylsilyloxy)disiloxane, 1,3-dicyclohexyl-1, 1,3,3-tetrakis[(norbornen-2-yl)ethyldimethylsilyloxy]disiloxane, 1,3-divinyltetramethyldisiloxane, 1,1,3,3,5,5-hexamethyl-1,5-bis[2-(5-norbornen-2-yl)ethyl]trisiloxane, silatrane glycol, 1,1,3,3-tetramethyl-1,3-bis[2-(5-norbornen-2-yl)ethyl]disiloxane, 2,4,6, 8-tetramethyl-2,4, 6,8-tetravinylcyclotetrasiloxane, and N-[3-(trimethoxysilyl)propyl]-]Sn-(4-vinylbenzyl)ethylenediamine.

In some aspects, the base resin composition includes gel compositions such that the effluent polymer is absorbed into or swells the gel. The effluent can be released from the gel via syneresis. For example, syneresis can be triggered by the compression of the curable mixture matrix under external pressure such as that caused by the aqueous medium. In some aspects, the crosslink density and structural integrity of the gel are chosen such that the effluent is released only when the vessel is at speed. Because the structural integrity of the gel can be controlled, e.g. using the crosslink density, the structural integrity can be chosen such that a greater amount of the effluent can be release as the speed of the vessel increases.

In some aspects, gel compositions are made using interpenetrating polymer networks. For example, in some aspects the compositions include (i) a thermoset or thermoplastic polymer resin and (ii) polymerizable monomers; wherein upon curing the polymerizable monomers polymerize inside the thermoset or thermoplastic polymer to form an interpenetrating polymer network; and wherein the effluent polymer is diffused within the interpenetrating polymer network and swells the interpenetrating polymer network to form a effluent polymer swollen gel. In some aspects, the base resin composition comprises (i) polymerizable first monomers capable of polymerization to form a thermoset or thermoplastic polymer resin and (ii) a polymerizable second monomers; wherein upon curing the polymerizable first monomers polymerize inside the thermoset or thermoplastic polymer to form an interpenetrating polymer network; and wherein the effluent polymer is diffused within the interpenetrating polymer network and swells the interpenetrating polymer network to form a effluent polymer swollen gel.

Thermosetting resins are well known [A. W. Birley, and M. Scott, Plastic Materials, Properties and Applications, Leonard Hill, Glasgow (1982)]. Among them, epoxy and vinyl-ester resins are suitable for protective coating applications thanks to their good chemical resistance and adhesion.

The gel can include polymeric siloxane network polymers such as those described in US 2008/0017070 A1, the contents of which are incorporated by reference herein. The compositions can include thermosetting resins, combined to siloxane components by the sol-gel process, to form a network which is modified with the introduction of metals such as Molybdenum, Boron or Tungsten.

In the marine field there is a need for coatings characterized by high chemical resistance and capable of being easily cured in cold and damp environments. Chemical resistance is particularly important in tank-coating applications. The development of low temperature fast curing and chemically resistant materials without the need of a catalyst are therefore still in demand. Promising coatings are those obtained by sol-gel techniques from liquid silane precursors in that they show high cross-linking levels and have good mechanical properties and chemical resistance. Sol-gel techniques are well known to the experts and described in The Physics and Chemistry of Sol-Gel Processing, C. J. Brinker, G. W. Scherer, Sol-Gel Science: Academic Press, London, 1990. In addition, techniques for introducing silica by the sol-gel method in organic matrices have been developed, and are described in patent application WO0125343, which outlines some routes for the production of interpenetrating organic-inorganic networks

The base resin composition can include hydrolysable polymers such that the base resin is gradually hydrolyzed in the aqueous medium. This creates a self-polishing effect in that, as the surface degrades a new underlayer is exposed. The hydrolysis of the matrix can be controlled to control the gradual release of the effluent polymer, and therefore the lifetime of the coating. In some aspects, the base resin is covalently linked to the effluent polymer via a cleavable linker. For example, a hydrolysable linker can be used to covalently bond the effluent to the base matrix. Gradual hydrolysis of this bond can lead to gradual release of the effluent polymer over time. Suitable linkers can include polydimethylsiloxane dithiol, 4-arm-PEG-maleimide, PEG-diester-dithiol, reaction products of an amine and an N-hydroxy succinimide, reaction products of a polyglycerol and a sebasic acid, and the derivatives thereof.

Effluent Polymers

The coatings and coating compositions include an effluent polymer. As discussed above, the effluent polymer released at or near the surface helps to reduce drag via the Toms effect. The effluent polymer can include hydrophilic polymers and/or polyelectrolytes, preferably those having a high molecular weight of at least 50,000 Daltons, at least 80,000 Daltons, at least 100,000 Daltons, at least 120,000 Daltons, or at least 150,000 Daltons.

In some aspects, the effluent polymer is selected from the group consisting of Poly(N-isopropylacrylamide), Polyacrylamide, Poly(2-oxazoline), Polyethylenimine, Poly(acrylic acid), Polymethacrylate, Poly(ethylene glycol), Polyglycerol, Poly(ethylene oxide), Poly(vinyl alcohol), Poly(vinylpyrrolidone), Polyelectrolytes, Cucurbit[n]uril Hydrate, Maleic Anhydride Copolymers, Polyethers, Polyvinyl alcohol-co-polyvinyl acetate, co-polymers thereof, polyisobutylene, guar gum, and blends thereof.

In some aspects, the effluent polymer is selected from the group consisting of Poly(styrenesulfonate), Polyacrylamide-based Polyelectrolytes, Poly(acrylic acid) salts, Poly(allylamine hydrochloride), Poly(diallyldimethylammonium chloride), Poly(vinyl acid), co-polymers thereof, and blends thereof.

The effluent polymer can be included in the compositions and coatings in any suitable amount to deliver the appropriate level of drag reduction. In some aspects, the effluent polymer is present in the composition or the coating in an amount from about 1 wt % to about 30 wt %, about 3 wt % to about 30 wt %, about 5 wt % to about 30 wt %, or about 8 wt % to about 20 wt % based upon a total weight of the coating composition.

The longevity of drag reduction coating can be improved by increasing its reservoir of effluent polymer. To improve the effluent reservoir capacity, a porous micro structure can be incorporated into the polymeric materials. With the addition of porosity, effluent-infused polymeric materials system may act as a sponge, absorbing a greater content of effluent polymer to provide a larger reservoir of effluent. Through control of porosity, pore size distribution and effluent loading, the bulk properties of the material may be controlled.

In some aspects, the solidifiable composition can include additives that impart specific properties that may be desired for particular applications. For example, the solidifiable composition can include microparticle and/or nanoparticle fillers to enhance mechanical properties or roughness, anti-oxidants, uv-stabilizers, foaming or anti-foaming agents, pigments, fluorescent dyes, nucleating agents (typically to control the crystallinity of the solid and thus affect their optical, thermal, and mechanical properties) or fillers to control optical properties or viscosity or ease and uniformity of application. In one or more aspects, the particles can include inorganic oxides and silicates, pozzolan, clays, kaolin, metakaolin, fly ash, and diatomaceous earth. Particles can also be added to add color or opacity to the composition.

Any method known for the preparation of microporous polymer bodies can be used to prepare a porous effluent-infused polymeric materials system. In one aspect, a sacrificial material, e.g., a porogen, can be used. An exemplary templating method uses a sugar cube template to produce a 3D interconnected porous network. Similarly, an alternative approach relies on introducing a porogen, such as sugar or salt, into the pre-cured mixture, and then removing the porogen to generate pores. These methods of 3D porous polymer synthesis create interconnected porosity in the polymer, where the pore size is dictated by the size of the porogen. The generation of an interconnected porous network is useful for systems in which the effluent does not swell the polymer system. The interconnected pores can create effluent inclusions that are capable of migration to the polymer surface. In some aspects, the porogen is a particle and the particle size in the range of 50 nm to 1 mm. The larger particle will provide an interconnected network. In certain aspects, the porogen is water in an oil in water emulsion. Water is present in the range of 1-1000 PHR (parts per hundred resin). The higher water levels will provide an interconnected network.

In other aspects, the porous polymer possesses an isolated porous network. An isolated porous network may be more robust and can be suitable for applications demanding material integrity. Because the pores are isolated, such porous polymer systems employ effluents that swell in the polymeric network. Thus, the effluents can be stored in the pore void space and can move to the surface through bulk diffusion.

In other aspects, the isolated porous network suitable for use in the solidifiable polymer composition described herein can be prepared using microemulsion templating. Microporous polymer system can be generated using emulsion templating, followed by immediate loading with effluents. This approach relies on a water-in-oil emulsion, in which the polymerizable material is in a continuous oil phase and the water phase acts as a particulate “sacrificial” material. The polymer precursor in the continuous phase polymerizes to form a continuous network around the templates aqueous phase droplets In order to improve the stability of the emulsion, a co-surfactant may be introduced. The non-continuous phase can be droplets on the order of 100 nm to 20 μm in diameter. The non-continuous phase can be present in the range of 1-25 PHR (parts per hundred resin). Upon curing, the infusion of effluents into the porous polymer displaces the water from the system, due to a combination of compatible surface energies between the substrate and effluents and less favorable interactions between the substrate and water.

In other aspects, effluents can be added to the emulsion system, allowing the effluents to be entrained within the polymer while curing. In some embodiments, the amount of added effluents can be in the range of 1 PHR to 200 PHR (PHR=part per hundred resin). For oil-infused porous system where effluents is added after curing, the ratio of effluents to resin can be as high as 1:1, and be even be a higher ratio with higher porosity. For oil-infused one-pot system where effluents is added before curing, the ratio of effluents to resin can be as high as 2:1 (and may be even higher with greater effluents loading).

In some aspects, additional effluents is infused into the porous polymer to displace the water from the system, due to a combination of compatible surface energies between the substrate and effluents and less favorable interactions between the substrate and water. In other aspects, no further additional effluents is added. The pore volume can be interconnected or isolated. In one or more embodiments, the pore diameter is in the range of 100 nm to 30 μm. The range specified here is for isolated pores made from emulsion-templated method. The pore size for interconnected pores will be dependent on the size of porogens used which is typically in ˜1 um-1 mm range.

Slippery Liquid-Infused Porous Surfaces

In some aspects, the single coating can utilize both mechanisms simultaneously (FIG. 1, panel d), the coating can provide a passively working solution to achieve significant drag reduction in naval applications. In some aspects, the drag-reducing coating can further include a plurality of particles, wherein the particles in the plurality of particles are dispersed in the base resin to form a uniformly-textured surface in the drag-reducing coating; and a lubricating liquid, wherein the lubricating liquid is chemically and physically matched with the base resin in such a way that, when cured therewith to form a cured composition, the lubricating liquid spontaneously provides an overlayer of the lubricating liquid at an exposed surface of the cured composition to form a slippery coating on the surface. The matching of the lubricating liquid with the base resin and a roughness of the uniformly-textured surface are such that the lubricating liquid is stably immobilized within the uniformly-textured surface. The suitable particles and lubricants can include any of those described in PCT/US2013/050406; in PCT/US2014/025935; and in PCT/US2017/025889, the contents of each of these is incorporated by reference herein.

In some aspects, a first coating can be applied to the nose region of a marine vessel where the first coating releases an effluent polymer to reduce drag through the Toms effect. A second coating can be applied to other parts of the marine vessel, e.g. in the stern region or the rest of the entire hull. The second coating can be a slippery coating such as a slippery liquid-infused polymer coating to increase the slippage of the effluent polymer and medium passing the surface.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

### Example 1. Exemplary Condensation Cure Polysiloxane Based Polymer Composite Containing a Hydrophilic Polymer Effluent

The coating formulation consists of 17.5 g of silanol (MW ˜100 kDa), 70 g of silanol (MW 50 kDa), 140 g of silanol (MW 25 kDa), 70 g of silanol (MW 3 kDa), 45 g of poly(diethoxysiloxane), 150 g of poly(ethylene oxide) (MW 200 kDa) and 30 wt. % of PTFE micronized powder (primary particle size <500 nm).

### Additional Prophetic Examples

A hydrophilic polymer effluent, poly(ethylene oxide) (MW 200 kDa), can be mixed into a commercial silicone kit, such as Dow DOWSIL™ 3-4207 Dielectric Tough Gel Green, with a high-shear mixing device at a ratio of 1:1000. The mixture is then applied as a coating on a solid surface after applying a primer and a tie-coat.

A highly stretchable and tough interpenetrated network (e.g. as described by J-Y Sun et al., Nature, vol. 489, pp. 133-136 (2012)) can be applied as a coating on a solid surface after applying a primer and a tie-coat followed by soaking in a bath of hydrophilic polymer effluent solution to displace water and to introduce the hydrophilic polymer effluent into the hydrogel network.

A highly cross-linked polyacrylamide-based hydrogel coating can be formed from an aqueous solution where a hydrophilic polymer effluent is co-dissolved (40% acrylamide, 5% N, N-methylenebisacrylamide, 2% ammoniumpersulfate, and 1% guar gum dissolved in deionized water).

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

The disclosure will be better understood upon reading the following aspects, which should not be confused with the claims. In addition, any of the aspects described herein may by interchanged or combined, and in some cases can be combined with any of the aspects described elsewhere in this disclosure.

The present disclosure will be better understood upon reading the following aspects which should not be confused with the claims. Further, each of these aspects can be in combination of one or more assets described elsewhere herein.

Aspect 1. A composite composition capable of curing to form a drag-reducing coating on a surface, the composite composition comprising: a base resin composition capable of curing to form a coating on the surface; and an effluent polymer dispersed in the base resin in such a way that, when an exposed surface of the drag-reducing coating is exposed to an aqueous medium, the effluent polymer migrates to the exposed surface of the drag-reducing coating and into the aqueous medium at or near the exposed surface to create a diluted effluent polymer solution in the aqueous medium at or near the exposed surface; wherein the diluted effluent polymer solution reduces a drag of the surface moving through the aqueous medium.

Aspect 2. The composite composition according to any one of aspects 1-35, wherein the base resin composition comprises (i) a curable thermoset or thermoplastic polymer resin and (ii) polymerizable monomers; wherein upon curing the polymerizable monomers polymerize inside the thermoset or thermoplastic polymer to form an interpenetrating polymer network; and wherein the effluent polymer is diffused within the interpenetrating polymer network and swells the interpenetrating polymer network to form a effluent polymer swollen gel.

Aspect 3. The composite composition according to any one of aspects 1-35, wherein the thermoset or thermoplastic polymer is selected from the group consisting of epoxy resin, polyacrylate, polyester, polyamide, polyimide, polyurethane, polyurea, polycarbonate, polysulfone, alkyd resin, polyphenol, polycyanurate, polysiloxane, crosslinked fluorinated polyol-based resin, polyurethane-polysiloxane hybrid sol-gel binder, organopolysilazane, polyolefin, polyvinylchloride, polyvnylalcohol, polyvinylacetate, ethylene-vinylacetate copolymer, cellulose, polylactic acid, thermoplastic polyurethane, thermoplastic hydrogel, silicone hydrogel, polyolefin dispersion, polyurethane dispersion, polyalkylene naphthalate, polyalkylene glycol, polyphosphate, ionic polymer, copolymers thereof, and blends thereof.

Aspect 4. The composite composition according to any one of aspects 1-35, wherein the polymerizable monomers are selected from the group consisting of ionic monomers, water soluble monomers, polar monomers, silicone monomers, non-polar monomers, synthetic esters, synthetic phosphates, fluorinated monomers, and combinations thereof.

Aspect 5. The composite composition according to any one of aspects 1-35, wherein the polymerizable monomers are ionic monomers selected from the group consisting of (meth)acrylic acid, (Meth)acryloxyethyldimethylbenzyl ammonium chloride, (Meth)acryloxyethyltrimethyl ammonium chloride, Dimethylaminoethyl (meth)acrylate, Sodium 1-allyloxy-2-hydroxy propane sulphonate, β-carboxyethyl acrylate, carboxystyrene, vinylbenzenesulfonic acid, 1-vinyl-3-alkylimidazole halide, Ethylene glycol (meth)acrylate phosphate and its salt

Aspect 6. The composite composition according to any one of aspects 1-35, wherein the polymerizable monomers are polar monomers selected from the group consisting of Terminal-functional PAG (polyalkyleneglycol) with (meth)acrylate, vinyl, thiol, alkyne, amino, dopamine, maleimide, N-hydroxysuccinimide activated carboxyl functional groups.

Aspect 7. The composite composition according to any one of aspects 1-35, wherein the polymerizable monomers are silicone monomers selected from the group consisting of Vinyl-based silicones and derivatives, Si—H based silicones and derivatives, Silanols, Alkoxy-based silicones and derivatives, and combinations thereof.

Aspect 8. The composite composition according to any one of aspects 1-35, wherein the polymerizable monomers are polar monomers selected from the group consisting of acrylates, methacrylates, allyls, vinyls, maleates, and itaconates with long or branching alkyl chains, like lauryl (meth)acrylate, 10-Undecenyl (meth)acrylate, 2-Ethylhexyl (meth)acrylate, Isodecyl (meth)acrylate, Isooctyl (meth)acrylate; styrene; precursors for polycarbonate like biphenol A; precursors for polyester like dicarboxyl compounds and dihydroxyl compounds; and combinations thereof.

Aspect 9. The composite composition according to any one of aspects 1-35, wherein the polymerizable monomers are synthetic esters or phosphates selected from the group consisting of (Meth)acrylate monomer like alkyl (meth)acrylate, styrene and its derivative; precursor for polycarbonate like biphenol A; Nylon like pentamethylene diamine and sebacic acid; polyester like dicarboxyl compounds and dihydroxyl compounds, precursors for organophosphorus polymer like diethyl vinylphosphonate and diisopropyl vinylphosphonate; and combinations thereof.

Aspect 10. The composite composition according to any one of aspects 1-35, wherein the polymerizable monomers are fluorinated monomers selected from the group consisting of fluorinates acrylates, methacrylates, allyls, vinyls, maleates, and itaconates.

Aspect 11. The composite composition according to any one of aspects 1-35, wherein the base resin composition comprises (i) polymerizable first monomers capable of polymerization to form a curable thermoset or thermoplastic polymer resin and (ii) a polymerizable second monomers; wherein upon curing the polymerizable first monomers polymerize inside the thermoset or thermoplastic polymer to form an interpenetrating polymer network; and wherein the effluent polymer is diffused within the interpenetrating polymer network and swells the interpenetrating polymer network to form a effluent polymer swollen gel.

Aspect 12. The composite composition according to any one of aspects 1-35, wherein the base resin composition comprises sol-gel based polysiloxanes or perhydropolysilazanes that can form a hybrid matrix with another organic reactive monomers/precursors.

Aspect 13. The composite composition according to any one of aspects 1-35, wherein the base resin composition comprises organotitanate or organozirconate precursors having M-OR reactive groups where M is a metal, —OR is an alkoxy such that that the M-OR bond is capable of forming M-OH via hydrolysis.

Aspect 14. The composite composition according to any one of aspects 1-35, wherein the base resin composition comprises precursors to a sol-gel reaction such as silicon tetraethoxide, tetraethyl orthosilicate (TEOS) and/or a pre-formed polymer such as polyurethanes having reactive groups for sol-gel reactions including alkoxysilanes and silanols; often these pre-formed polymer based sol-gel precursors are mixed with a composition comprising TEOS and an alcohol based solvent (e.g. EtOH or IPA); catalyzed by a weak acid such as acetic acid or a dilute HCl.

Aspect 15. The composite composition according to any one of aspects 1-35, wherein the effluent polymer is covalently attached to the base resin.

Aspect 16. The composite composition according to any one of aspects 1-35, wherein the effluent polymer is covalently attached via a hydrolysable linkage; and wherein the hydrolysable linkage comprises polydimethylsiloxane dithiol, 4-arm-PEG-maleimide, PEG-diester-dithiol, reaction products of an amine and an N-hydroxy succinimide, reaction products of a polyglycerol and a sebasic acid, and the derivatives thereof.

Aspect 17. The composite composition according to any one of aspects 1-35, wherein the composition comprises hydrolysable particles comprising the effluent polymer encapsulated within a hydrolysable shell.

Aspect 18. The composite composition according to any one of aspects 1-35, wherein the effluent polymer is encapsulated in such a way that it is chemically matched with the base resin.

Aspect 19. The composite composition according to any one of aspects 1-35, wherein the hydrolysable shell comprises polydimethylsiloxane, poly(oxyethylene), poly(oxypropylene), copolymers thereof, or blends thereof.

Aspect 20. The composite composition according to any one of aspects 1-35, wherein the base resin composition comprises a curable hydrolysable polymer; and wherein the curable hydrolysable polymer, when cured, forms a self-polishing coating that gradually dissolves in the aqueous medium to release the effluent polymer.

Aspect 21. The composite composition according to any one of aspects 1-35, wherein the base resin comprises a compound selected from the group consisting of polysiloxane, fluoropolymer, epoxy, alkyd, polyurethane, polyester, polyolefin, polysilazane, polyacrylate, and a co-polymer or a blend thereof.

Aspect 22. The composite composition according to any one of aspects 1-35, wherein the effluent polymer is a hydrophilic polymer.

Aspect 23. The composite composition according to any one of aspects 1-35, wherein the effluent polymer has an average molecular weight of about 100,000 Daltons or more.

Aspect 24. The composite composition according to any one of aspects 1-35, wherein the effluent polymer is selected from the group consisting of Poly(N-isopropylacrylamide), Polyacrylamide, Poly(2-oxazoline), Polyethylenimine, Poly(acrylic acid), Polymethacrylate, Poly(ethylene glycol), Polyglycerol, Poly(ethylene oxide), Poly(alkylene glycol), Polysaccharide, Poly(vinyl alcohol), Poly(vinylpyrrolidone), Polyelectrolytes, Cucurbit[n]uril Hydrate, Maleic Anhydride Copolymers, Polyethers, Polyvinyl alcohol-co-polyvinyl acetate, co-polymers thereof, and blends thereof.

Aspect 25. The composite composition according to any one of aspects 1-35, wherein the effluent polymer comprises a polyelectrolyte.

Aspect 26. The composite composition according to any one of aspects 1-35, wherein the effluent polymer is selected from the group consisting of Poly(styrenesulfonate), Polyacrylamide-based Polyelectrolytes, Poly(acrylic acid) salts, Poly(allylamine hydrochloride), Poly(diallyldimethylammonium chloride), Poly(vinyl acid), co-polymers thereof, and blends thereof.

Aspect 27. The composite composition according to any one of aspects 1-35, further comprising a plurality of particles, wherein the particles in the plurality of particles are dispersed in the base resin to form a uniformly-textured surface in the drag-reducing coating; and a lubricating liquid, wherein the lubricating liquid is chemically and physically matched with the base resin in such a way that, when cured therewith to form a cured composition, the lubricating liquid spontaneously provides an overlayer of the lubricating liquid at an exposed surface of the cured composition to form a slippery coating on the surface.

Aspect 28. The composite composition according to any one of aspects 1-35, wherein the matching of the lubricating liquid with the base resin and a roughness of the uniformly-textured surface are such that the lubricating liquid is stably immobilized within the uniformly-textured surface

Aspect 29. The composite composition according to any one of aspects 1-35, wherein the effluent polymer is a hydrophilic polymer.

Aspect 30. The composite composition according to any one of aspects 1-35, wherein the effluent polymer has an average molecular weight of about 100,000 Daltons or more.

Aspect 31. The composite composition according to any one of aspects 1-35, wherein the effluent polymer is selected from the group consisting of Poly(N-isopropylacrylamide), Polyacrylamide, Poly(2-oxazoline), Polyethylenimine, Poly(acrylic acid), Polymethacrylate, Poly(ethylene glycol), Polyglycerol, Poly(ethylene oxide), Poly(alkylene glycol), Polysaccharide, Poly(vinyl alcohol), Poly(vinylpyrrolidone), Polyelectrolytes, Cucurbit[n]uril Hydrate, Maleic Anhydride Copolymers, Polyethers, Polyvinyl alcohol-co-polyvinyl acetate, co-polymers thereof, and blends thereof.

Aspect 32. The composite composition according to any one of aspects 1-35, wherein the effluent polymer comprises a polyelectrolyte.

Aspect 33. The composite composition according to any one of aspects 1-35, wherein the effluent polymer is selected from the group consisting of Poly(styrenesulfonate), Polyacrylamide-based Polyelectrolytes, Poly(acrylic acid) salts, Poly(allylamine hydrochloride), Poly(diallyldimethylammonium chloride), Poly(vinyl acid), co-polymers thereof, and blends thereof.

Aspect 34. The composite composition according to any one of aspects 1-35, wherein the base resin composition further comprises one or more additives, wherein the one or more additives are present at an amount less than 5 wt. % based upon a total weight of the solid components of the base resin composition.

Aspect 35. The composite composition according to any one of aspects 1-34, further comprising a biocide.

Aspect 36. A drag-reducing coating formed by a process of applying a composition according to any one of aspects 1-40 to a surface of a substrate; and curing and/or drying the composition to form the drag-reducing coating on the surface.

Aspect 37. A drag-reducing coating comprising: a base resin coating a portion of a substrate; and a hydrophilic effluent polymer dispersed in the base resin in such a way that, when an exposed surface of the drag-reducing coating is exposed to an aqueous medium, the effluents migrate to the exposed surface of the drag-reducing coating and into the aqueous medium at or near the exposed surface to create a diluted effluent solution in the aqueous medium at or near the exposed surface; wherein the diluted effluent solution reduces a drag of the surface moving through the aqueous medium.

Aspect 38. The drag-reducing coating according to any one of aspects 36-66, wherein the base resin comprises an interpenetrating polymer network; wherein the hydrophilic effluent polymer is diffused within the interpenetrating polymer network and swells the interpenetrating polymer network to form a hydrophilic effluent polymer swollen gel.

Aspect 39. The drag-reducing coating according to any one of aspects 36-66, wherein the interpenetrating polymer network comprises a first network formed via addition polymerization or condensation polymerization by a catalyst or by a thermal initiation and a second network that is interpenetrated with the first network and formed via addition polymerization or condensation polymerization by an applied energy such as UV, LED, wherein the order of forming the first and the second network can also be reversed.

Aspect 40. The drag-reducing coating according to any one of aspects 36-66, wherein the base resin comprises a hybrid matrix formed of a sol-gel based polysiloxanes or perhydropolysilazanes that have been reacted with other organic reactive monomers or precursors.

Aspect 41. The drag-reducing coating according to any one of aspects 36-66, wherein the base resin comprises a gel formed from sol gel crosslinking of a pre-formed polymer such as polyurethanes having reactive groups for sol-gel reactions and a silicon tetraethoxide or tetraethyl orthosilicate (TEOS).

Aspect 42. The drag-reducing coating according to any one of aspects 36-66, wherein the effluent polymer is covalently attached to the base resin.

Aspect 43. The drag-reducing coating according to any one of aspects 36-66, wherein the effluent polymer is covalently attached via a hydrolysable linkage; and wherein the hydrolysable linkage comprises polydimethylsiloxane dithiol, 4-arm-PEG-maleimide, PEG-diester-dithiol, reaction products of an amine and an N-hydroxy succinimide, reaction products of a polyglycerol and a sebasic acid, and the derivatives thereof.

Aspect 44. The drag-reducing coating according to any one of aspects 36-66, wherein the hydrophilic effluent polymer is encapsulated within hydrolysable particles; and wherein the hydrolysable particles are dispersed in the base resin.

Aspect 45. The drag-reducing coating according to any one of aspects 36-66, wherein the effluent polymer is encapsulated in such a way that it is chemically matched with the base resin.

Aspect 46. The drag-reducing coating according to any one of aspects 36-66, wherein the hydrolysable particles comprise polydimethylsiloxane, poly(oxyethylene), poly(oxypropylene), copolymers thereof, or blends thereof.

Aspect 47. The drag-reducing coating according to any one of aspects 36-66, wherein the base resin composition comprises a hydrolysable polymer; and wherein the hydrolysable polymer hydrolyses in an aqueous medium to release the hydrophilic effluent polymer.

Aspect 48. The drag-reducing coating according to any one of aspects 36-66, wherein the hydrolysable polymer comprises polydimethylsiloxane, poly(oxyethylene), poly(oxypropylene), copolymers thereof, or blends thereof.

Aspect 49. The drag-reducing coating according to any one of aspects 36-66, further comprising a plurality of particles, wherein the particles in the plurality of particles are dispersed in the base resin to form a uniformly-textured surface in the drag-reducing coating; and a lubricating liquid, wherein the lubricating liquid is chemically and physically matched with the base resin in such a way that the lubricating liquid spontaneously provides an overlayer of the lubricating liquid at an exposed surface to form a slippery coating on the surface.

Aspect 50. The drag-reducing coating according to any one of aspects 36-66, wherein the matching of the lubricating liquid with the base resin and a roughness of the uniformly-textured surface are such that the lubricating liquid is stably immobilized within the uniformly-textured surface

Aspect 51. The drag-reducing coating according to any one of aspects 36-66, wherein the effluent polymer is a hydrophilic polymer.

Aspect 52. The drag-reducing coating according to any one of aspects 36-66, wherein the effluent polymer has an average molecular weight of about 100,000 Daltons or more.

Aspect 53. The drag-reducing coating according to any one of aspects 36-66, wherein the effluent polymer is selected from the group consisting of Poly(N-isopropylacrylamide), Polyacrylamide, Poly(2-oxazoline), Polyethylenimine, Poly(acrylic acid), Polymethacrylate, Poly(ethylene glycol), Polyglycerol, Poly(ethylene oxide), Poly(vinyl alcohol), Poly(vinylpyrrolidone), Polyelectrolytes, Cucurbit[n]uril Hydrate, Maleic Anhydride Copolymers, Polyethers, Polyvinyl alcohol-co-polyvinyl acetate, co-polymers thereof, and blends thereof.

Aspect 54. The drag-reducing coating according to any one of aspects 36-66, wherein the effluent polymer comprises a polyelectrolyte.

Aspect 55. The drag-reducing coating according to any one of aspects 36-66, wherein the effluent polymer is selected from the group consisting of Poly(styrenesulfonate), Polyacrylamide-based Polyelectrolytes, Poly(acrylic acid) salts, Poly(allylamine hydrochloride), Poly(diallyldimethylammonium chloride), Poly(vinyl acid), co-polymers thereof, and blends thereof.

Aspect 56. The drag-reducing coating according to any one of aspects 36-66, wherein the base resin composition further comprises one or more additives, wherein the one or more additives are present at an amount less than 5 wt. % based upon a total weight of the solid components of the base resin composition.

Aspect 57. The drag-reducing coating according to any one of aspects 36-66, further comprising a biocide.

Aspect 58. The drag-reducing coating according to any one of aspects 36-66, wherein the effluent polymer is a hydrophilic polymer.

Aspect 59. The drag-reducing coating according to any one of aspects 36-66, wherein the effluent polymer has an average molecular weight of about 100,000 Daltons or more.

Aspect 60. The drag-reducing coating according to any one of aspects 36-66, wherein the effluent polymer is selected from the group consisting of Poly(N-isopropylacrylamide), Polyacrylamide, Poly(2-oxazoline), Polyethylenimine, Poly(acrylic acid), Polymethacrylate, Poly(ethylene glycol), Polyglycerol, Poly(ethylene oxide), Poly(vinyl alcohol), Poly(vinylpyrrolidone), Polyelectrolytes, Cucurbit[n]uril Hydrate, Maleic Anhydride Copolymers, Polyethers, Polyvinyl alcohol-co-polyvinyl acetate, co-polymers thereof, and blends thereof.

Aspect 61. The drag-reducing coating according to any one of aspects 36-66, wherein the effluent polymer comprises a polyelectrolyte.

Aspect 62. The drag-reducing coating according to any one of aspects 36-66, wherein the effluent polymer is selected from the group consisting of Poly(styrenesulfonate), Polyacrylamide-based Polyelectrolytes, Poly(acrylic acid) salts, Poly(allylamine hydrochloride), Poly(diallyldimethylammonium chloride), Poly(vinyl acid), co-polymers thereof, and blends thereof.

Aspect 63. The drag-reducing coating according to any one of aspects 36-66, wherein the drag-reducing coating has a measurable slip length greater than 0 when exposed to a fluid flowing at Reynolds number less than 2,000.

Aspect 64. The drag-reducing coating according to any one of aspects 36-66, wherein the drag-reducing coating has a measurable slip length greater than 0 when exposed to a fluid flowing at Reynolds number greater than 2,000 and less than 10,000.

Aspect 65. The drag-reducing coating according to any one of aspects 36-66, wherein the drag-reducing coating has a measurable slip length greater than 0 when exposed to a fluid flowing at Reynolds number is equal or greater than 10,000 and less than 500,000.

Aspect 66. The drag-reducing coating according to any one of aspects 36-66, wherein the drag-reducing coating is on the surface of marine platforms, vessels (e.g. cargo ships, racing boats, ferries, recreational ships, yachts), vehicles (e.g. unmanned underwater vehicles), and naval warfare (e.g. naval ships, submarines, torpedoes, stealth vehicles).

Aspect 67. A marine vessel comprising a drag-reducing coating according to any one of aspects 36-66.

Aspect 68. A method of making a drag-reducing coating according to any one of aspects 36-66, the method comprising applying a composition according to any one of aspects 1-41 to a surface of a substrate; and curing and/or drying the composition to form the drag-reducing coating.

1. A composite composition capable of curing to form a drag-reducing coating on a surface, the composite composition comprising:
a base resin composition capable of curing to form a coating on the surface; and
an effluent polymer dispersed in the base resin in such a way that, when an exposed surface of the drag-reducing coating is exposed to an aqueous medium, the effluent polymer migrates to the exposed surface of the drag-reducing coating and into the aqueous medium at or near the exposed surface to create a diluted effluent polymer solution in the aqueous medium at or near the exposed surface;
wherein the diluted effluent polymer solution reduces a drag of the surface moving through the aqueous medium.

2. The composite composition of claim 1, wherein the base resin composition comprises (i) a curable thermoset or thermoplastic polymer resin and (ii) polymerizable monomers;
wherein upon curing the polymerizable monomers polymerize inside the thermoset or thermoplastic polymer to form an interpenetrating polymer network; and
wherein the effluent polymer is diffused within the interpenetrating polymer network and swells the interpenetrating polymer network to form an effluent polymer swollen gel.

3. The composite composition of claim 2, wherein the thermoset or thermoplastic polymer is selected from the group consisting of epoxy resin, polyacrylate, polyester, polyamide, polyimide, polyurethane, polyurea, polycarbonate, polysulfone, alkyd resin, polyphenol, polycyanurate, polysiloxane, crosslinked fluorinated polyol-based resin, polyurethane-polysiloxane hybrid sol-gel binder, organopolysilazane, polyolefin, polyvinylchloride, polyvnylalcohol, polyvinylacetate, ethylene-vinylacetate copolymer, cellulose, polylactic acid, thermoplastic polyurethane, thermoplastic hydrogel, silicone hydrogel, polyolefin dispersion, polyurethane dispersion, polyalkylene naphthalate, polyalkylene glycol, polyphosphate, ionic polymer, copolymers thereof, and blends thereof.

4. The composite composition of claim 2, wherein the polymerizable monomers are selected from the group consisting of ionic monomers, water soluble monomers, polar monomers, silicone monomers, non-polar monomers, synthetic esters, synthetic phosphates, fluorinated monomers, and combinations thereof.

5. The composite composition of claim 2, wherein the polymerizable monomers are ionic monomers selected from the group consisting of (meth)acrylic acid, (Meth)acryloxyethyldimethylbenzyl ammonium chloride, (Meth)acryloxyethyltrimethyl ammonium chloride, Dimethylaminoethyl (meth)acrylate, Sodium 1-allyloxy-2-hydroxy propane sulphonate, β-carboxyethyl acrylate, carboxystyrene, vinylbenzenesulfonic acid, 1-vinyl-3-alkylimidazole halide, Ethylene glycol (meth)acrylate phosphate and its salt

6. The composite composition of claim 2, wherein the polymerizable monomers are polar monomers selected from the group consisting of Terminal-functional PAG (polyalkyleneglycol) with (meth)acrylate, vinyl, thiol, alkyne, amino, dopamine, maleimide, N-hydroxysuccinimide activated carboxyl functional groups.

7. The composite composition of claim 2, wherein the polymerizable monomers are silicone monomers selected from the group consisting of Vinyl-based silicones and derivatives, Si—H based silicones and derivatives, Silanols, Alkoxy-based silicones and derivatives, and combinations thereof.

8. The composite composition of claim 2, wherein the polymerizable monomers are polar monomers selected from the group consisting of acrylates, methacrylates, allyls, vinyls, maleates, and itaconates with long or branching alkyl chains, like lauryl (meth)acrylate, 10-Undecenyl (meth)acrylate, 2-Ethylhexyl (meth)acrylate, Isodecyl (meth)acrylate, Isooctyl (meth)acrylate; styrene; precursors for polycarbonate like biphenol A; precursors for polyester like dicarboxyl compounds and dihydroxyl compounds; and combinations thereof.

9. The composite composition of claim 2, wherein the polymerizable monomers are synthetic esters or phosphates selected from the group consisting of (Meth)acrylate monomer like alkyl (meth)acrylate, styrene and its derivative; precursor for polycarbonate like biphenol A; Nylon like pentamethylene diamine and sebacic acid; polyester like dicarboxyl compounds and dihydroxyl compounds, precursors for organophosphorus polymer like diethyl vinylphosphonate and diisopropyl vinylphosphonate; and combinations thereof.

10. The composite composition of claim 2, wherein the polymerizable monomers are fluorinated monomers selected from the group consisting of fluorinates acrylates, methacrylates, allyls, vinyls, maleates, and itaconates.

11. (canceled)

12. (canceled)

13. (canceled)

14. (canceled)

15. (canceled)

16. (canceled)

17. The composite composition according to claim 1, wherein the composition comprises hydrolysable particles comprising the effluent polymer encapsulated within a hydrolysable shell.

18. The composite composition according to claim 17, wherein the effluent polymer is encapsulated in such a way that it is chemically matched with the base resin.

19. The composite composition according to claim 17, wherein the hydrolysable shell comprises polydimethylsiloxane, poly(oxyethylene), poly(oxypropylene), copolymers thereof, or blends thereof.

20. (canceled)

21. The composite composition according to claim 1, wherein the base resin comprises a compound selected from the group consisting of polysiloxane, fluoropolymer, epoxy, alkyd, polyurethane, polyester, polyolefin, polysilazane, polyacrylate, and a co-polymer or a blend thereof.

22. The composite composition according to claim 21, wherein the effluent polymer is a hydrophilic polymer.

23. (canceled)

24. The composite composition according to claim 21, wherein the effluent polymer is selected from the group consisting of Poly(N-isopropylacrylamide), Polyacrylamide, Poly(2-oxazoline), Polyethylenimine, Poly(acrylic acid), Polymethacrylate, Poly(ethylene glycol), Polyglycerol, Poly(ethylene oxide), Poly(alkylene glycol), Polysaccharide, Poly(vinyl alcohol), Poly(vinylpyrrolidone), Polyelectrolytes, Cucurbit[n]uril Hydrate, Maleic Anhydride Copolymers, Polyethers, Polyvinyl alcohol-co-polyvinyl acetate, co-polymers thereof, and blends thereof.

25. (canceled)

26. (canceled)

27. (canceled)

28. (canceled)

29. (canceled)

30. (canceled)

31. (canceled)

32. (canceled)

33. (canceled)

34. The composite composition according to claim 1, wherein the base resin composition further comprises one or more additives, wherein the one or more additives are present at an amount less than 5 wt. % based upon a total weight of the solid components of the base resin composition.

35. The composite composition according to claim 1, further comprising a biocide.

36. (canceled)

37. (canceled)

38. (canceled)

39. (canceled)

40. (canceled)

41. (canceled)

42. A drag-reducing coating comprising:
a base resin coating a portion of a substrate; and
a hydrophilic effluent polymer dispersed in the base resin in such a way that, when an exposed surface of the drag-reducing coating is exposed to an aqueous medium, the effluents migrate to the exposed surface of the drag-reducing coating and into the aqueous medium at or near the exposed surface to create a diluted effluent solution in the aqueous medium at or near the exposed surface;
wherein the diluted effluent solution reduces a drag of the surface moving through the aqueous medium.

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. A method of making a drag-reducing coating according to claim 42, the method comprising
applying a composition according to any one of claims 1-41 to a surface of a substrate; and
curing and/or drying the composition to form the drag-reducing coating.
